(19) United States
(12) Patent Application Publication
(10) Pub. No.: US 2022/0090539 A1
(43) Pub. Date: Mar. 24, 2022

(54) FLEXIBLE CARBON CAPTURE AND STORAGE SYSTEM FOR PRODUCING A LOW CARBON SOURCE OF ELECTRICITY

(71) Applicants: Ramachandran Krishnamurthy, Bridgewater, NJ (US); Makini Byron, West Orange, NJ (US)

(72) Inventors: Ramachandran Krishnamurthy, Bridgewater, NJ (US); Makini Byron, West Orange, NJ (US)

(21) Appl. No.: 17/477,930

(22) Filed: Sep. 17, 2021

Related U.S. Application Data
(60) Provisional application No. 63/082,744, filed on Sep. 24, 2020.

(51) Int. Cl. F02C 6/14; F02C 7/22; F02C 3/22

(52) U.S. Cl. CPC F02C 6/14; F02C 7/22; F02C 3/22; C25B 1/04; F05D 2220/76; F05D 2240/35; F05D 2220/32

(57) ABSTRACT

The present invention relates to an integrated process that enables cost-effective low carbon power production for natural gas combined cycle (NGCC) power plants utilizing the Linde-BASF advanced amine carbon capture technology and hydrogen technologies. The present invention is a flexible carbon capture and storage (FLECCS) system incorporating the NGCC, a post combustion capture (PCC) plant, a proton exchange membrane (PEM) electrolyzer, hydrogen compression and storage tanks.

### BACKGROUND OF THE INVENTION

### Field of the Invention

The present invention relates to an integrated process that enables cost-effective low carbon power production for natural gas combined cycle (NGCC) power plants utilizing the Linde-BASF advanced amine carbon capture technology and hydrogen technologies. The present invention is a flexible carbon capture and storage (FLECCS) system incorporating the NGCC, a post combustion capture (PCC) plant, a proton exchange membrane (PEM) electrolyzer, hydrogen compression and storage tanks.

### Description of Related Art

NGCC power plants include several pieces of technology.

Carbon Capture: With reference to FIG. 1, the Linde-BASF carbon capture unit operation is based on a typical lean-rich solvent absorption/regeneration cycle for CO₂ capture but leverages several key features for both solvent and process optimization. BASF's early solvent development efforts resulted in the formulation of new, next generation solvents, such as OASE® blue. The optimized properties of the OASE® blue solvent lead to capital and operating cost reduction due to several factors including: (1) efficient CO₂ capture from low pressure sources through favorable reaction kinetics and reduced reboiler steam energy consumption, (2) demonstrated longer stability than monoethanolamine (MEA), and (3) a lower solvent circulation rate. In addition to advances in solvent design, Linde has achieved significant improvements in process design that further reduce the cost of CO₂ capture from NGCC plants. The Linde-BASF process and the process improvements that have been achieved during the development of the technology are outlined in FIG. 1. In addition to the benefits the OASE® blue solvent provides, the key Linde-BASF process features include: (1) high-capacity structured packing enabling a reduced absorber diameter and capital costs, (2) regeneration of CO₂ at elevated pressure (3.4 bara) allowing for lower downstream compression costs and compressor capital expenses, (3) novel solvent emissions control at top wash section of absorber using patented dry-bed configuration, (4) optimized heat transfer in rich/lean exchanger and heat recovery through use of the stripper interstage heater or lean vapor compression design options, (5) a fast-response reboiler design, and (6) a reduced solvent circulation rate.

Hydrogen production: The effectiveness of the present invention, as further discussed below, leverages the ability to integrate electrolyzers to an NGCC power plant. Electrolyzers chemically separate water into hydrogen and oxygen using electricity as a feedstock. Synergistic opportunities may exist between electrolyzers and natural gas power plants with low utilization rates. A Proton Exchange Membrane (PEM) electrolyzer cell is composed of an anode chamber, a cathode chamber, two electrode catalyst surfaces and a proton exchange membrane. A minimum potential of 1.23V (reversible voltage) is applied across the electrochemical cell to initiate electrochemical reactions at both anode and cathode electrodes. Water is introduced at the anode and dissociated into oxygen, protons and electrons via the following reaction:

Anode: H₂O→½O₂+2H⁺+2e⁻

The hydrogen ions are driven through the membrane to the cathode under an electric field where they combine with the electrons arriving from the external circuit to form hydrogen gas:

Cathode: 2H⁺+2e^{-→H}₂

Polymer Electrolyte Membrane (PEM) electrolysis is one of the most promising technologies for producing hydrogen (H₂) from electricity due to its fast response time, high current density, and the potential for operation over a wide range of power inputs. The present invention leverages the advantages of PEM electrolyzers to increase the overall capital utilization of a fossil-based power plant that is outfitted with carbon capture technologies in a future market where low-carbon electricity is required. Other water electrolyzer systems such as alkaline or solid oxide electrolyzer technologies can be employed for hydrogen production depending on scale and performance needed.

Hydrogen compression and storage: The produced hydrogen is generated at 30 bar through electrochemical compression in the Linde-ITM PEM electrolyzers. The proposed system will make use of conventional compression technologies to increase the pressure of the hydrogen to 350 bars. The proposed invention will utilize Type IV compressed gas cylinders for hydrogen storage at 350 bars. Additionally, other storage facilities and means are contemplated based on hydrogen capacity, such as salt caverns.

The proposed invention targets an improved capital recovery factor for an NGCC power plant with carbon capture by shifting the power generated to the unit operation that will create the most value to the overall plant at each point in time. Thus, one of the advantages on the present invention is that it provides a cost-effective and firm low-carbon electricity resource based on natural gas combined cycle power plants.

Typical operation of a carbon capture plant and an electrolyzer assumes constant operation at a given power set-point and minimization of system upsets or changes. For these systems, the flexibility to respond to demand changes comes at a high cost as the units must be sized for maximum demand, even if the average operation is significantly below the peak. It is one of the goals of the present invention to provide a process that optimally sizes the carbon capture plant, the electrolyzer and hydrogen storage system to both achieve 90% capture of power plant CO₂ emissions and provide hydrogen to meet the demand of the power plant without perturbation.

Other objects and aspects of the present invention will become apparent to one of ordinary skill in the art upon review of the specification, drawings and claims appended hereto.

### SUMMARY OF THE INVENTION

According to an aspect of the invention, an integrated power plant with a flexible carbon capture and storage system for producing a low carbon source of power. The integrated power plant includes:
(a) operating in a first mode where the excess power from a NGCC is transmitted to an electrolyzer to produce hydrogen and oxygen which is stored for later utilization in the power plant; and
(b) operating in a second mode where the stored hydrogen and oxygen is utilized in various operational units of the integrated power plant to produce power exported to the grid.

### BRIEF DESCRIPTION OF THE FIGURES

The objects and advantages of the invention will be better understood from the following detailed description of the preferred embodiments thereof in connection with the accompanying figures wherein like numbers denote same features throughout and wherein:

FIG. 1 is a process flow diagram of the Linde-BASF advanced amine carbon capture unit (PCC); and

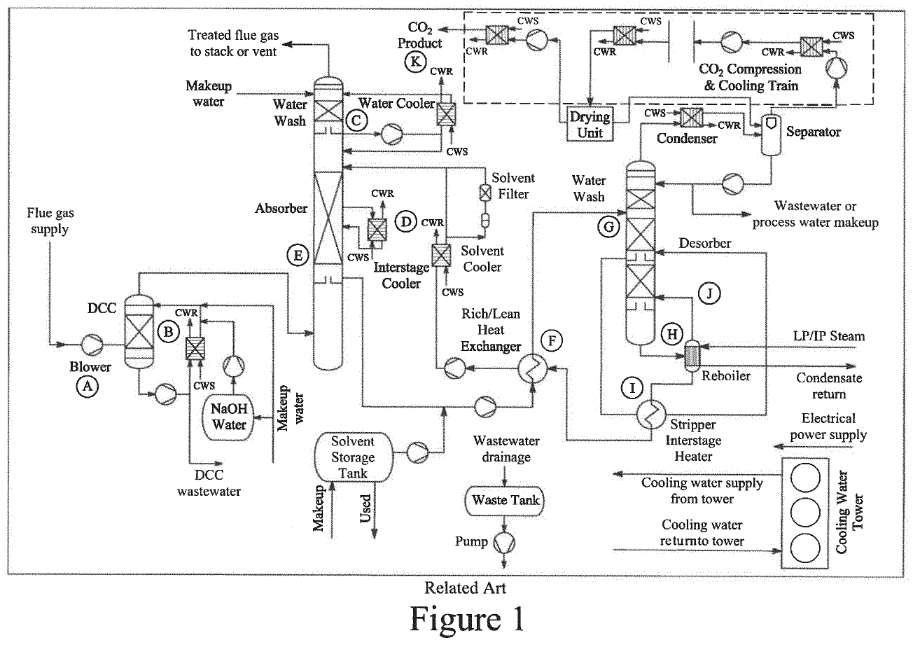

FIG. 2 illustrates an exemplary embodiment of the present invention integrated natural gas combined cycle power plant.

### DETAILED DESCRIPTION OF THE INVENTION

The present invention provides an improved capital recovery factor for an NGCC power plant with carbon capture by shifting the power generated to the unit operation that will create the most value to the overall plant at each point in time.

The grid of the future is anticipated to have three main drivers: 1) produce power with low carbon intensity; 2) maintain steady and reliable output; and 3) provide electricity at affordable prices. However, current solutions are challenged to satisfy all three criteria simultaneously. The present invention addresses all three technical problems with an integrated process solution that leverages Linde technologies and combines them in an optimal way.

1) Production of low carbon intensity electricity. Future markets are anticipated to have a mandate for low carbon intensity. The Linde-BASF PCC technology has been proven to capture 90% of carbon emissions from fossil-based flue gas in two pilot plants in Neideraussem, Germany (0.5 MWe) and Wisonville, AL (1.5 MWe) respectively. Currently, the technology is designed to operate under baseload conditions. Variations in the inputs of heat and mass flows could result in increased emissions, or lower volumes of captured CO₂ as the system adjusts to respond to changes in setpoints. This present invention enables the Linde-BASF carbon capture plant to operate under more steady-state conditions and maintain the carbon capture efficiency in future markets with fluctuating demand from fossil-based power plants.

2) Steady and reliable power output from an NGCC power plant: While the carbon footprint of renewable electricity generating units is low, these sources are intermittent and notoriously unreliable. To meet the peak demand during periods when there is not enough renewable power generation, the grid relies on dispatchable generation: that is fossil fuel power plants that can adjust their power output on demand, in response to an order. Integration of hydrogen production and storage with a natural gas combined cycle (NGCC) power plant that has carbon capture, can support grid stabilization by enabling the fossil-fuel power plant to produce low carbon intensity power in those periods when renewable power generation is unavailable or insufficient to meet demand.

3) Affordable electricity prices. As the penetration of renewable energy within the grid grows, daytime power prices are anticipated to decrease due to supply congestion and dispatchable sources, such as NGCC power plants, are likely to be ramped down or turned off. However, as peak electricity demand is anticipated to continue, dispatchable sources will still be required. The cost of electricity from dispatchable sources during peak periods is therefore likely to increase due overall reduced utilization of fossil-based power plant capital to only those periods of peak demand. The present invention seeks to moderate the price of electricity, by increasing the capital utilization of fossil-based power plants throughout the day, including periods of supply congestion from renewable sources.

The process of the present invention, described with reference to an exemplary embodiment below, allows the natural gas power plant with carbon capture to operate at a near steady state in electricity markets with fluctuating locational marginal prices (LMPs) due to a high penetration of variable renewable electricity (VRE). The benefits of the present integration include:

1) Reducing the LCOE in electricity markets with high penetration of VRE: As the penetration of variable renewable energy (VRE) increases, so does the electric power system cost due to the curtailment and underutilization of installed fossil-based sources during times when renewable energy is at its peak, and the need for installation of large systems for energy storage, transmission and distribution. The present invention enables the implementation of firm low-carbon resources based on fossil energy that are dispatchable and can lower the cost of the electricity power system by addressing the needed generating and storage capacity and improving the utilization of installed fossil-based assets.

2) Increased efficiency of operation of dispatchable NGCC electricity generating units in markets with high VRE: Integration of hydrogen production and storage with a NGCC power plant that has carbon capture enables the plant to operate under more steady-state conditions and reduce the need for cycling on and off due to fluctuating electricity prices. Reducing frequent starts and stops within a large-scale NGCC power plant improves its efficiency, increase its capital utilization, and reduce its carbon emissions per generated kilowatt-hr.

3) Optimum capital utilization of an integrated system that uses NGCC, carbon capture technologies and hydrogen technologies: The integrated system and process of the present invention seeks to maximize the capital recovery factor of this integrated process by improving capital utilization of all equipment and generating multiple streams of revenue that can be used to offset the high capital costs of carbon capture from a natural gas power plant. This process is applicable to both retrofits of existing power generators as well as greenfield systems.

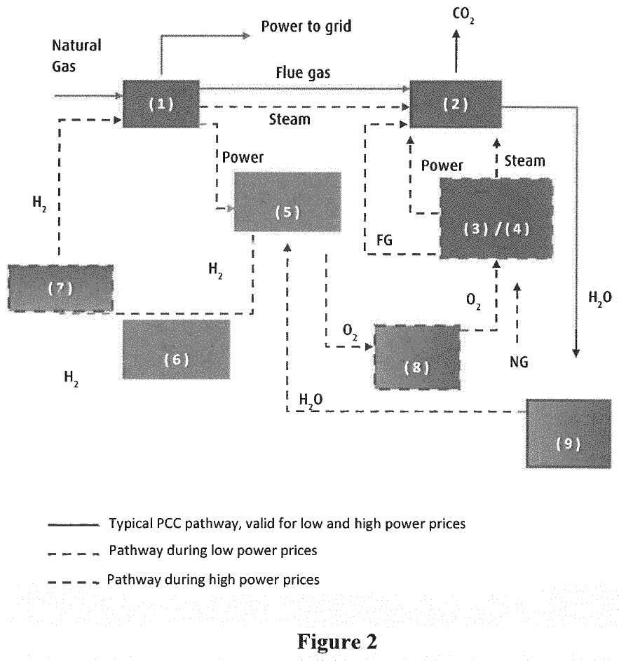

With reference to FIG. 2, an exemplary embodiment is utilized to further describe the invention. The integrated, yet flexible carbon capture and storage system includes the natural gas combined cycle power plant (1); an advance amine post combustion capture (PCC) unit (2), such as the one provided Linde-BASF; (3) a packaged boiler (3); a steam turbine (4); an electrolyzer (5) such as the above referenced Linde-ITM proton exchange membrane; hydrogen processing and compression unit (6); compressed gaseous hydrogen storage tank (7); compressed gaseous oxygen storage tank (8); and water storage tank (9).

The integrated process consists of two modes of operation for the power plant. Mode 1 (or first mode) which is defined herein as those times when the marginal cost to operate the power plant is below the locational marginal price (LMP). The system will leverage low electricity prices and excess power from the NGCC power plant to operate an electrolyzer and produce hydrogen and oxygen that can be stored onsite for later use within the system. This allows the power plant to maintain its operation, albeit at a load that is below its rated capacity. The PCC plant can also continue to operate, though it will require some time to adjust to changes in load as well. The PCC plant can make use of low pressure (LP) steam and electric power extracted from the power plant. The process integration enables optimal sizing of the PCC plant and electrolyzer couple to maintain PCC operation within the range between its capture capacity and minimum turndown.

In operation Mode 2, the LMP is higher than the marginal cost to operate the plant and the electrolyzer is not used. Instead the plant can maximize its revenue by producing electricity to export to the grid and the stored hydrogen can be utilized within the NGCC power plant. The hydrogen produced from PEM electrolysis can be used for many different applications within an NGCC power plant. One such application is the co-firing of hydrogen with natural gas inside the gas turbine (GT) of the NGCC. This option generates a power output that is slightly above the rated capacity of the NGCC.

Options for further increasing the system efficiency include utilization of the stored oxygen for oxy combustion in an auxiliary boiler to produce steam for PCC use when LMP is high. Use of auxiliary boiler would maximize the revenue potential from electricity sales. The high CO₂ content flue gas generated from the oxy-fired boiler would also increase the inlet flue gas CO₂ concentration to the PCC. Water that is produced during the PCC operation may also be stored for recycling to the electrolyzer for hydrogen production, though this is expected to add costs for water purification to reduce fouling the catalyst in the electrolyzer. This process is modular and configurable to power plants, depending on their needs and arrangements. It would be applicable to both retrofits of existing power generators, as well as greenfield systems. For instance, another option for the use of the oxygen in the system is to pressurize it and use it in the gas turbine which uses natural gas and the stored hydrogen as fuel and air as the oxidant. Oxygen can replace the oxidant, thereby contributing to an efficiency increase in the turbine with a resultant decrease in CO₂ generated.

While the invention has been described in detail with reference to specific embodiments thereof, it will become apparent to one skilled in the art that various changes and modifications can be made, and equivalents employed, without departing from the scope of the appended claims.

What is claimed is:

1. An integrated power plant with a flexible carbon capture and storage system for producing a low carbon source of power, comprising:
(c) operating in a first mode where the excess power from a NGCC is transmitted to an electrolyzer to produce hydrogen and oxygen which is stored for later utilization in the power plant; and
(d) operating in a second mode where the stored hydrogen and oxygen is utilized in various operational units of the integrated power plant to produce power exported to the grid.

2. The integrated power plant with a flexible carbon capture and storage system of claim 1, where the marginal cost of operating the power plant is below a locational marginal price in step (a).

3. The integrated power plant with a flexible carbon capture and storage system of claim 1, where the marginal cost of operating the power plant is above a locational marginal price in step (b) and the power generated is exported to a power grid.

4. The integrated power plant with a flexible carbon capture and storage system of claim 1, where in step (a) the hydrogen and oxygen produced by the electrolyzer is routed to a compression unit operation and storage tanks, respectively.

5. The integrated power plant with a flexible carbon capture and storage system of claim 1, where in step (b) the hydrogen is routed from the storage unit to the NGCC as fuel.

6. The integrated power plant with a flexible carbon capture and storage system of claim 1, where in step (b) the oxygen is routed to an oxy-fuel combustion unit to drive a steam turbine.

7. The integrated power plant with a flexible carbon capture and storage system of claim 6, where power generated by the steam turbine is routed to an amine post-combustion capture unit.
